(19) United States
(12) Patent Application Publication
(10) Pub. No.: US 2017/0098419 A1
(43) Pub. Date: Apr. 6, 2017

(54) LCD Panel and Driving Method Thereof

(71) Applicant: Shenzhen China Star Optoelectronics Technology Co., Ltd., Shenzhen, Guangdong (CN)

(72) Inventors: Chih-tsung KANG, Shenzhen, Guangdong (CN); Lixuan CHEN, Shenzhen, Guangdong (CN)

(73) Assignee: Shenzhen China Star Optoelectronics Technology Co., Ltd., Shenzhen, Guangdong (CN)

(21) Appl. No.: 14/779,679

(22) PCT Filed: May 29, 2015
(86) PCT No.: PCT/CN2015/080195

§ 371 Date: Sep. 24, 2015

(30) Foreign Application Priority Data
May 21, 2015 (CN) 201510264226.7

(51) Int. Cl. G09G 3/36; G09G 3/20

(52) U.S. Cl. CPC G09G 3/3607; G09G 3/2074; G09G 3/2003; G09G 3/3688; G09G 2320/0276; G09G 2300/0443; G09G 2320/0242

(57) ABSTRACT

A method for driving a liquid crystal panel comprises providing a liquid crystal panel with a plurality of pixel units in a matrix with M columns and N rows, wherein each of the pixel unit has at least a blue sub-pixel, dividing the liquid crystal panel into multiple display units, wherein each display unit comprises two of the pixel units, providing a gray level value, B, to the blue sub-pixels of each of the display units with a higher gray level value, BH, and a lower gray level value, BL, to the blue sub-pixels respectively, wherein the combination of BH and BL results the blue sub-pixels in the display unit to approach a predetermined Gamma Curve, and γ=1.8˜2.4 at a perspective viewing angle. This invention also discloses a liquid display panel comprising the driving method mentioned above

### BACKGROUND OF THE INVENTION

1. Field of the Invention

This invention is related the liquid crystal display. More particularly, it's related to a liquid crystal panel and driving method thereof.

2. The Related Arts

LCD (liquid Crystal Display) is a flat and thin display device. It is composed of a certain quantity of color, black and white pixels disposed in front of a light source or a reflector. LCD is currently widely accepted and becomes the mainstream display device due to its low power consumption, high display quality, compact size and light weight. It's widely adopted in various electronic device, such as computing devices, mobile phones, or digit photo frames. The wide viewing angle technology is one of the hot spots of the LCD industry. However, the color shift issue inevitably occurs while viewing at a large angle.

To solve this color shift issue, a 2D1G technology is adapted. 2D1G means a technology to divide each pixel into a main pixel and a sub pixel. The main pixel and the sub pixel have different areas. The main pixel and sub pixel of each pixel are connected to the same gate line and different data lines respectively. By inputting different signal (gray level value) via the different data lines to the main pixel and the sub pixel, it generates different display brightness and brightness at a large angel to lower the color shift issues while viewing at a large angle. However, the data lines are doubled after dividing each pixel into a main pixel and a sub pixel. The aperture ratio would be reduced to affect the transmittance, and the display quality would be lowered as well.

### SUMMARY OF THE INVENTION

In view of this, an object of the invention is to provide a liquid crystal panel and a driving method by changing the driving method of the liquid crystal panel, simulating 2D1G display panel behavior in the conventional RGB three pixels in the liquid crystal panel to reduce the side view or perspective color shift problems arising.

To achieve the above object, the present invention employs the following technical solutions:

A method for driving a liquid crystal panel comprises providing a liquid crystal panel with a plurality of pixel units in a matrix with M columns and N rows, wherein each of the pixel unit has at least a blue sub-pixel, dividing the liquid crystal panel into multiple display units, wherein each display unit comprises two of the pixel units, providing a gray level value, B, to the blue sub-pixels of each of the display units with a higher gray level value, BH, and a lower gray level value, BL, to the blue sub-pixels respectively, wherein the combination of BH and BL results the blue sub-pixels in the display unit to approach a predetermined Gamma Curve, and γ=1.8˜2.4 at a perspective viewing angle.

Preferably, the pixel units in the display unit are adjacent to each other.

Preferably, the pixel units in the display unit are located in the same column and in different rows which are spaced apart by another.

Preferably, the pixel units in the display unit are located in the same column and in different rows which are adjacent to each other and the pixel unit in the same column and the row which is adjacent receive higher BH than the other pixel unit in the display unit.

Preferably, the pixel units in the display unit are located in the same row and in different columns which are adjacent to each other and the pixel unit in the same row and the column which is adjacent receive higher BH than the other pixel unit in the display unit.

Preferably, the step of providing a gray level value, B, to the blue sub-pixels of each of the display units with a higher gray level value, BH, and a lower gray level value, BL further comprises:

S101, acquiring a relationship between the gray level value B₀ of the blue sub-pixel at a front viewing angle α and the actual brightness LvαB₀ in the curve B₀−LvαB₀;

S102, acquiring a relationship between the gray level value B₀ of the blue sub-pixel at a perspective viewing angle β and the actual brightness LvβB₀ in the curve B₀−LvβB₀;

S103, acquiring the relation curve B−LvαB and B−LvβB under the gray level value B and a theoretical brightness LvB at the front viewing angle α and the perspective viewing angle β in accordance with the equation

$${( \frac{B}{255} )}^{γ} = \frac{Lv α B}{Lv α ( 255 )} and {( \frac{B}{255} )}^{γ} = \frac{Lv β B}{Lv β ( 255 )} ,$$

wherein the Lvα(255) and Lvβ(255) are looked up from the relation curves B₀−LvαB₀ and B₀−LvβB₀

S104, BH and BL of the gray level value B to the blue sub pixels in the display unit are in accordance with the following equations:

Δ1=LvαB+LvαB−Lvα(BH)−Lvα(BL);

Δ2=LvβB+LvβB−Lvβ(BH)−Lvβ(BL);

y=Δ1²+Δ2²;

Wherein y is the minimum, LvαB and LvβB are looked up from curves B−LvαB and B−LvβB, Lvα(BH) and Lvα(BL) are looked up from B₀−LvαB₀, and Lvβ(BH) and Lvβ(BL) are looked up from B₀−LvβB₀; and

S105, resetting a look up table (LUT) for each of the gray level value B of the blue sub-pixels in the display unit to acquire a combination of BH and BL in accordance with S104.

Preferably, the front viewing angle α is Wand the perspective viewing angle β is 30˜80.°

Preferably, the front viewing angle α is Wand the perspective viewing angle β is 60°

Preferably, the pixel unit further comprises a red sub-pixel and a green-sub pixel, and the data signals of the red sub-pixel and the green sub-pixel is constant while resetting the data line signal of the blue sub-pixel

Preferably, the predetermined Gamma curve is γ=2.2.

This invention also discloses a liquid display panel comprising a gate controller, a source controller, and an active area having a plurality of pixel units in a matrix with M columns and N rows and at least one blue sub-pixel in each pixel unit, wherein the driving method of the liquid crystal display is followed by the method mentioned above

The beneficial effects:

The present invention provides a liquid crystal panel and a driving method, the traditional three-pixel LCD panel RGB analog 2D1G panel display by changing the driving method to reduce color shift problem generated when the side view or perspective, without comparing small aperture ratio LCD panel was not to protect the quality of the liquid crystal panel

### BRIEF DESCRIPTION OF THE DRAWINGS

The detailed descriptions accompanying drawings and the embodiment of the present invention are as follows, which allows the technical solutions and other beneficial effects of the present invention more obvious.

FIG. 1 is a schematic structural view of the embodiment of a liquid crystal panel in the present invention.

FIG. 2 is a schematic structural view of the embodiment of a pixel unit in the present invention.

FIG. 3 is an exemplary illustration of a driving method of a data signal to the display unit in one embodiment of the present invention

FIG. 4 provides an actual brightness curve of the blue sub-pixel at a front viewing angle and a perspective viewing angle of the liquid crystal panel in one embodiment of the invention.

FIG. 5 is a schematic diagram to illustrate one of the dividing methods of the display unit in the present invention.

FIG. 6 is a schematic diagram to illustrate another of the dividing methods of the display unit in the present invention.

FIG. 7 is a schematic diagram to illustrate another of the dividing methods of the display unit in the present invention.

FIG. 8 is a schematic diagram to illustrate another of the dividing methods of the display unit in the present invention

### DETAILED DESCRIPTION OF THE PREFERRED EMBODIMENTS

In order to more clearly describe the technical solutions and the effects in the present invention, the preferred embodiment of the present invention accompanying drawings are described in detail as follows.

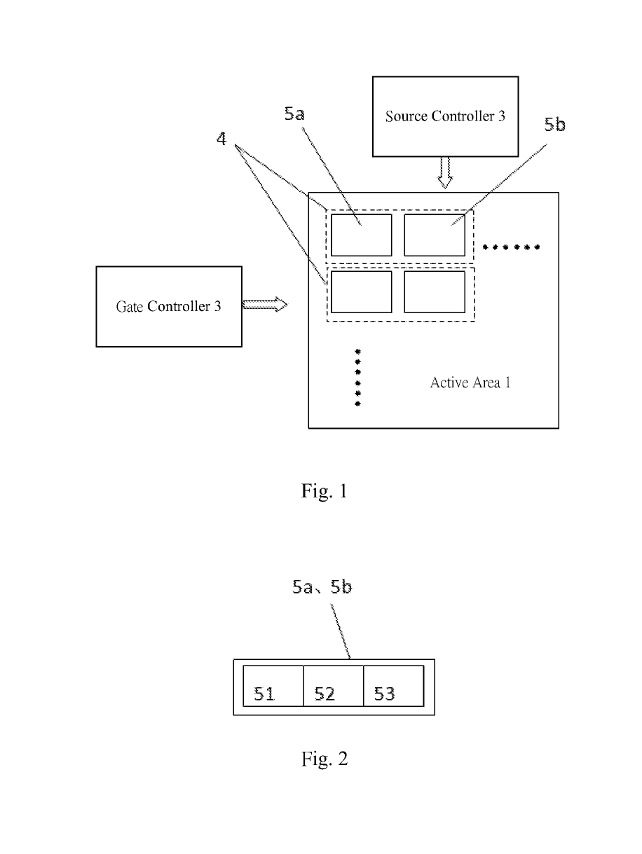

With reference FIG. 1 and FIG. 2, the conventional liquid crystal panel comprises an active area 1 having a plurality of pixel units 5a/5b in a matrix with M columns and N rows, a gate controller 2, and a source controller 3. The gate controller 2 provides a scan signal to the pixel unit 5a/5b via a plurality of data lines and each of the pixel units 5a/5b comprises a red sub-pixel 51, a green sub-pixel 52, and a blue sub-pixel 53.

The present embodiment is achieved by changing the method for driving a liquid crystal panel, analog 2D1G panel display in three RGB pixels as a conventional liquid crystal panel, to reduce color shift problems when a side view or perspective

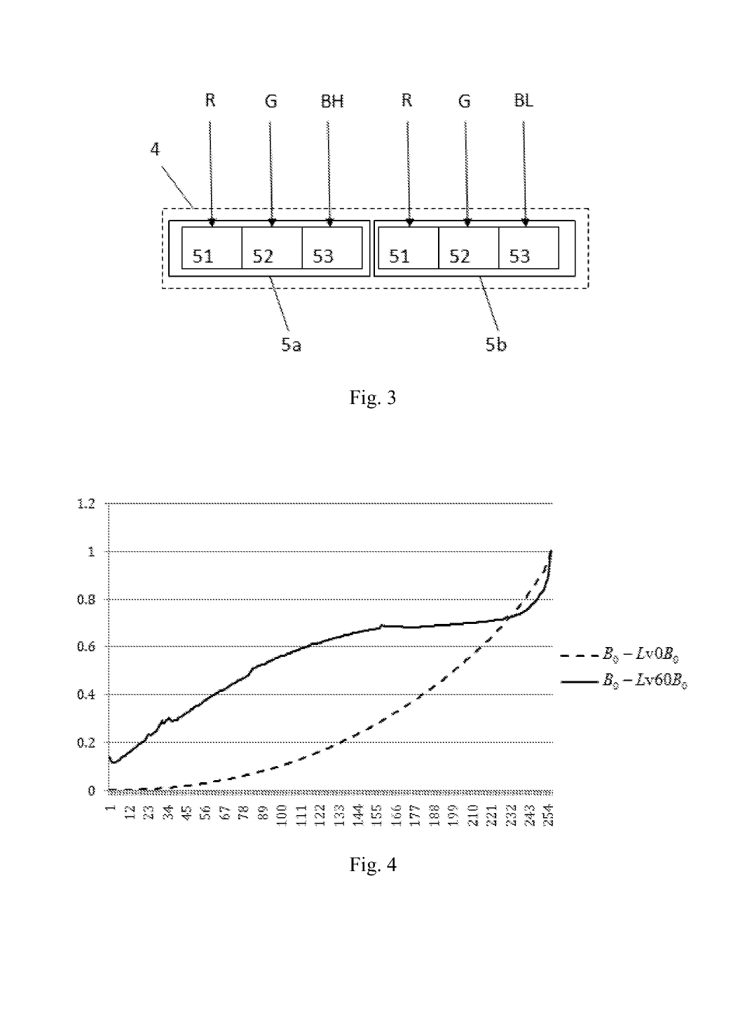

To achieve this, with reference to FIG. 1 and FIG. 3, the active area 1 of the liquid crystal panel is divided into a plurality of display units 4. Each display unit 4 comprises a first pixel unit 5a and a second pixel unit 5b. While driving the liquid crystal panel, for the gray level value B of the blue sub-pixels 53 which is required by the display unit, this embodiment provides a higher gray level value BH to the blue sub-pixel of the first pixel unit 5a, and a lower gray level value BL to the blue sub-pixel of the second pixel unit 5b. The combination of BL and BH makes the brightness curve of the sub-pixels 53 of the display unit approach a predetermined Gamma (γ) curve at a perspective viewing angle. The Gamma (γ) curve is determined upon the actual requirement of the liquid display panel. In an embodiment, γ could be 1.8˜2.4. FIG. 3 is an exemplary illustration of a driving method of a data signal to the display unit 4. With reference to FIG. 3, in the two pixel units 5a/5b of the display unit 4, the data signals of R and G to the red sub-pixel 51 and the green sub-pixel 52 are kept consistently while resetting the data signal BH and BL of the blue sub-pixels 53.

wherein the front viewing angle α is Wand the perspective viewing angle β is 30˜80.°

With reference to FIGS. 1-3, the step of providing a gray level value, B, to the blue sub-pixels of each of the display units with a higher gray level value, BH, and a lower gray level value, BL further comprising:

S101, acquiring a relationship between the gray level value B₀ of the blue sub-pixel at a front viewing angle α and the actual brightness LvαB₀ in the curve B₀−LvαB₀;

S102, acquiring a relationship between the gray level value B₀ of the blue sub-pixel at a perspective viewing angle β and the actual brightness LvβB₀ in the curve B₀−LvβB₀;

S103, calculate to obtain the gray level B of the blue sub-pixel 53 at the front viewing angle α and the perspective viewing angle β, B−Lv0B and B−Lv60B, respectively in the LvB relationship curve B−LvαB and B−LvβB in accordance with the equations:

$${( \frac{B}{255} )}^{2.2} = \frac{Lv 0 B}{Lv 0 ( 255 )} and {( \frac{B}{255} )}^{2.2} = \frac{Lv 60 B}{Lv 60 ( 255 )} .$$

Lvα(255) and Lvβ(255) are respectively looked up from the relation curve B₀−LvαB₀ and B₀−LvβB₀.

S104, while the gray level value B of the blue sub-pixel units is required by the display unit 4, the gray level value BH in the blue sub-pixel 53 of the first pixel unit 5a and the gray level value BL in the blue sub-pixel 53 of the second pixel unit 5b would satisfy the following equations:

Δ1=LvαB+LvαB−Lvα(BH)−Lvα(BL);

Δ2=LvβB+LvβB−Lvβ(BH)−Lvβ(BL);

y=Δ1²+Δ2²;

wherein y is the minimum, LvαB and LvβB are looked up from curves B−LvαB and B−LvβB, Lvα(BH) and Lvα(BL) are looked up from B₀−LvαB₀, and Lvβ(BH) and Lvβ(BL) are looked up from B₀−LvβB₀

S105, resetting a look up table (LUT) for each of the gray level value B of the blue sub-pixels in the display unit to acquire a combination of BH and BL in accordance with S104.

The following embodiment describes the gray level value B and combination of divided gray level value BH and BL at the γ=2.2 in the Gamma curve, the front viewing angle α=0 and the perspective angle β=60°.

First, acquire the gray level value B₀ of the blue sub-pixel 53 at the front viewing angle α=0° and the actual brightness Lv0B₀ in accordance the relationship curve B₀−Lv60B₀ at the perspective viewing angle β=60°. Please refer to FIG. 4. FIG. 4 illustrates a relationship curve, wherein the gray level of the liquid crystal level comprises 256 gray levels, from 0 to 255.

Subsequently, calculate the gray level B of the blue sub-pixel 53 at the front viewing angle α=0° and the perspective viewing angle β=60°, B−Lv0B and B−Lv60B, respectively in the LvB relationship curve B−Lv0B and B−Lv60B in accordance with the equations:

$${( \frac{B}{255} )}^{2.2} = \frac{Lv 0 B}{Lv 0 ( 255 )} and {( \frac{B}{255} )}^{2.2} = \frac{Lv 60 B}{Lv 60 ( 255 )} .$$

In the aforementioned equations, acquire the brightness at B₀=255 in the relationship curve B₀−Lv0B₀ at the front viewing angle α=0° and the brightness at B₀=255 in the relationship curve B₀−Lv60B₀ at the front viewing angle β=60°.

Moreover, if the display unit 4 requires a gray level value B in the blue sub-pixel 54 (the original gray level inputs to the blue sub-pixels in the first pixel unit 5a and the second pixel unit 5b are both B), instead of B, the input of the gray level value to the blue sub-pixel 53 in the first pixel unit 5a is BH, and the input of the gray level value to the blue sub-pixel 53 in the second pixel unit 5b is BL in accordance with the following equations:

Δ1=Lv0B+Lv0B−Lv0(BH)−Lv0(BL);

Δ2=Lv60B+Lv60B−Lv60(BH)−Lv60(BL);

y=Δ1²+Δ2²;

While the gray level value B of the blue sub-pixel is confirmed, look up the value Lv0B and Lv60B in the theoretical brightness curves, B−Lv0B and B−Lv60B. Meanwhile, look up Lv0(BH) and Lv0(BL) in the actual brightness curve B₀−Lv0B₀, and Lv60(BH) and Lv60(BL) in the actual brightness curve B₀−Lv60B₀ to make y being minimum for obtaining the corresponding gray level value BH and BL.

At last, obtain a corresponding combination of BH and BL according to the aforementioned calculation for each gray level value B of the blue sub-pixel 53 is required by the display unit, and reset the look up table of the blue sub-pixel 53 in the liquid crystal panel. During driving the liquid crystal panel, if the gray level value B of the blue sub-pixels 53 is required by the display unit 53 when display a first picture, obtain the gray level value to the blue sub-pixel 53 in the first pixel unit 5a is BH, and the gray level value to the blue sub-pixel 53 in the second pixel unit 5b is BL.

The layout of the first pixel unit 5a and the second pixel unit 5b in the display unit 4 could be in the same column and in the adjacent rows. Since the gray level values of the first pixel unit 5a and the second pixel unit 5b are derived from the same gray level value B, the difference is large and incurs the difference of the resolution in the horizontal direction in such layout. While the BL is extremely low, it would cause the loss of the resolution. Besides, in such layout, there is a whole column of the first pixel units 5a for receiving the higher gray level value BH and a whole column of the second pixel units 5b for receiving the lower gray level value BL. This would cause further the resolution loss.

For solving the issues mentioned above, this invention provides several embodiments of layout of the first pixel unit 5a and the second pixel unit 5b:

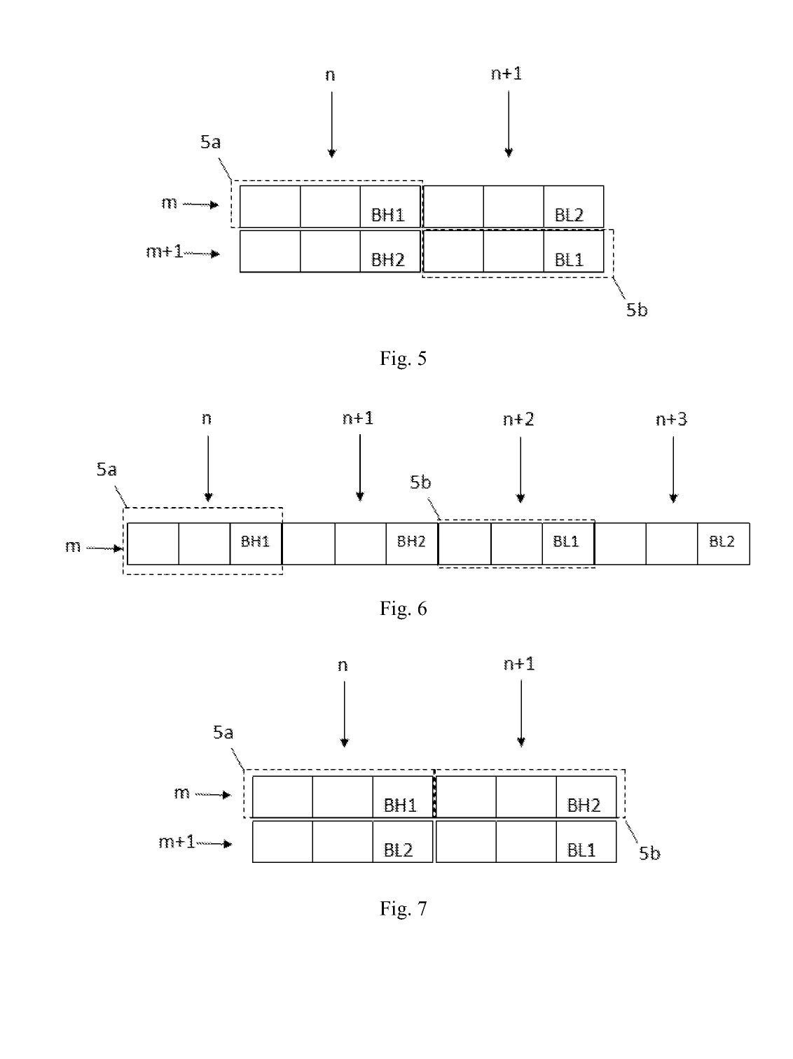

(1) the first pixel unit 5a and the second pixel unit 5b are disposed in the pixel units in the adjacent columns and rows. Specifically, with reference to FIG. 5, the first pixel unit 5a is the pixel unit in the m-th column and the n-th row, the second pixel unit 5b is the pixel unit in the (m+1)-th column and the (n+1)-th row, and the first pixel unit 5a and the second pixel unit 5b are formed a display unit. The other two pixel units in the (m+1)-th column and n-th row and in the m-th column and (n+1)-th row are formed another display unit. While the gray level value to the blue sub-pixel of the pixel unit in the m-th column and n-th row is BH1, the gray level value to the blue sub-pixel of the pixel unit in the (m+1)-th column and (n+1)-th row is BL1. In another display unit, the gray level value to the blue sub-pixel of the pixel unit in the (m+1)-th column and n-th row is BH2 and the gray level value to the blue sub-pixel of the pixel unit in the m-th column and (n+1)-th row is BL2, wherein m=1, 3, 5 . . . , M and n=1, 3, 5 . . . , N.

According the aforementioned layout of the first pixel unit 5a and the second pixel unit 5b, the higher gray level value BH and the lower gray level value BL derived from the same gray level value B are inputted to two of the blue sub-pixels in the adjacent pixels which belongs to different columns to reduce the resolution loss in the horizontal directions. Even BH1 and BL2 are inputted to the adjacent two pixel units in the same columns, the difference would not be large since BH1 and BL2 are derived from different gray level value B.

(2) the first pixel unit 5a and the second pixel unit 5b are disposed in the same column and in different rows which is spaced by another. Specifically, with reference to FIG. 6, the first pixel unit is the pixel unit in the m-th column and the n-th row, and the second pixel unit 5b is the pixel unit in the m-th column and the (n+2)-th pixel unit. The aforementioned first pixel unit 5a and the second pixel unit 5b are formed a display unit. The pixel unit in the m-th column and the (n+1)-th row, and the pixel unit in the m-th column and the (n+3)-th row are formed another display unit. While the gray level value to the blue sub-pixel of the pixel unit in the m-th column and n-th row is BH1, the gray level value to the blue sub-pixel of the pixel unit in the m-th column and (n+2)-th row is BL1. In another display unit, the gray level value to the blue sub-pixel of the pixel unit in the m-th column and (n+1)-th row is BH2 and the gray level value to the blue sub-pixel of the pixel unit in the m-th column and (n+3)-th row is BL2, wherein m=1, 2, 3 . . . , M and n=1, 4, 9 . . . , N.

According the aforementioned layout of the first pixel unit 5a and the second pixel unit 5b, the higher gray level value BH and the lower gray level value BL (BH1/BL1 and BH2/BL2) derived from the same gray level value B are inputted to two of the blue sub-pixels in the adjacent pixels which belongs to different columns to reduce the resolution loss in the horizontal directions.

(3) the first pixel unit 5a and the second pixel unit 5b are disposed in the same column and in adjacent rows respectively. For the pixel unit which receives the lower gray level value BL, there is another pixel unit receiving higher gray level value BH in the same row and in the adjacent column. For the pixel unit which receives the higher gray level value BH, there is another pixel unit receiving lower gray level value BL in the same row and in the adjacent column. Specifically, with reference to FIG. 7, the first pixel unit 5a is the pixel unit in the m-th column and the n-th row, and the second pixel unit 5b is the pixel unit in the m-th column and the (n+1)-th pixel unit. The aforementioned first pixel unit 5a and the second pixel unit 5b are formed a display unit. The pixel unit in the (m+1)-th column and the n-th row, and the pixel unit in the (m+1)-th column and the (n+1)-th row are formed another display unit. While the gray level value to the blue sub-pixel of the pixel unit in the m-th column and n-th row is BH1, the gray level value to the blue sub-pixel of the pixel unit in the m-th column and (n+1)-th row is BL1. In another display unit, the gray level value to the blue sub-pixel of the pixel unit in the (m+1)-th column and n-th row is BH2 and the gray level value to the blue sub-pixel of the pixel unit in the (m+1)-th column and n-th row is BL2, wherein m=1, 2, 3 . . . , M and n=1, 3, 5 . . . , N.

According the aforementioned layout of the first pixel unit 5a and the second pixel unit 5b, the higher gray level value BH and the lower gray level value BL (BH1/BL1 and BH2/BL2) derived from the same gray level value B are inputted to two of the blue sub-pixels in the adjacent pixels which belongs to the same column. However, in the two adjacent columns, the higher gray level value BH1 and the lower gray level value BL2 are complementary and the lower gray level value BL1 and the higher gray level value BH2 are complementary. Therefore, in general, the higher gray level value BH and lower gray level value BL are spaced by each other in the horizontal and vertical directions to reduce the resolution loss.

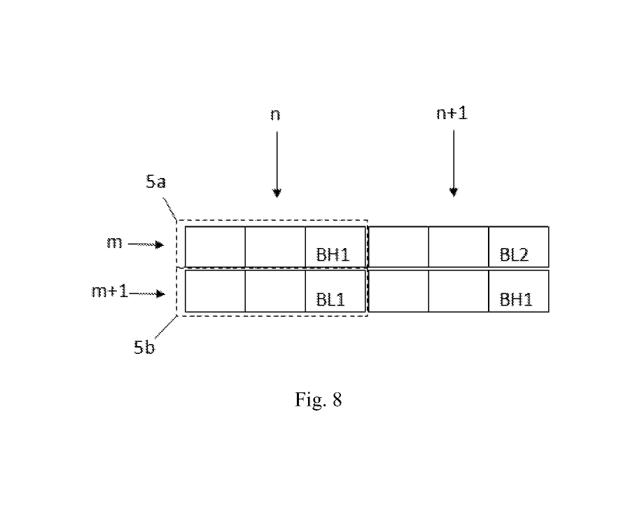

(4) The first pixel unit 5a and the second pixel unit 5b are disposed in the same row and in adjacent columns respectively. For the pixel unit which receives the lower gray level value BL, there is another pixel unit receiving higher gray level value BH in the same column and in the adjacent rows. Specifically, with reference to FIG. 8, the first pixel unit 5a is the pixel unit in the m-th column and the n-th row, and the second pixel unit 5b is the pixel unit in the (m+1)-th column and the n-th pixel unit. The aforementioned first pixel unit 5a and the second pixel unit 5b are formed a display unit. The pixel unit in the m-th column and the (n+1)-th row, and the pixel unit in the (m+1)-th column and the (n+1)-th row are formed another display unit. While the gray level value to the blue sub-pixel of the pixel unit in the m-th column and n-th row is BH1, the gray level value to the blue sub-pixel of the pixel unit in the (m+1)-th column and n-th row is BL1. In another display unit, the gray level value to the blue sub-pixel of the pixel unit in the m-th column and (n+1)-th row is BL2 and the gray level value to the blue sub-pixel of the pixel unit in the (m+1)-th column and (n+1)-th row is BH2, wherein m=1, 2, 3 . . . , M and n=1, 3, 5 . . . , N.

According the aforementioned layout of the first pixel unit 5a and the second pixel unit 5b, the higher gray level value BH and the lower gray level value BL (BH1/BL1 and BH2/BL2) derived from the same gray level value B are inputted to two of the blue sub-pixels in the adjacent pixels which belongs to the different columns. (For human eyes, there is no resolution loss while the gray level value difference is large in the same row and the two adjacent columns.) Therefore, in general, the higher gray level value BH and lower gray level value BL are spaced by each other in the horizontal and vertical directions to reduce the resolution loss

The liquid crystal panel and the driving method mention above comprises dividing the liquid crystal panel into multiple display units, wherein each display unit comprises two of the pixel units, and providing a gray level value, B, to the blue sub-pixels of each of the display units with a higher gray level value, BH, and a lower gray level value, BL, to the blue sub-pixels respectively to achieve the effect of the conventional 2D1G display panel to lower the color shift issue at a perspective viewing angle. Meanwhile, the aperture rate would not be reduced to ensure the quality of the display panel. This invention also discloses the various layout design of the two pixel units in each display unit to reduce the resolution loss in the horizontal direction.

The aforementioned descriptions merely represent the preferred embodiments of instant disclosure, without any intention to limit the scope of the instant disclosure which is fully described only within the following claims. Various equivalent changes, alterations or modifications based on the claims of the instant disclosure are all, consequently, viewed as being embraces by the scope of the instant disclosure.

What is claimed is:

1. A method for driving a liquid crystal panel, comprising:
providing a liquid crystal panel with a plurality of pixel units in a matrix with M columns and N rows, wherein each of the pixel unit has at least a blue sub-pixel;
dividing the liquid crystal panel into multiple display units, wherein each display unit comprises two of the pixel units;
providing a gray level value, B, to the blue sub-pixels of each of the display units with a higher gray level value, BH, and a lower gray level value, BL, to the blue sub-pixels respectively, wherein the combination of BH and BL results the blue sub-pixels in the display unit to approach a predetermined Gamma Curve, and γ=1.8˜2.4 at a perspective viewing angle;
wherein the pixel units in the display unit are adjacent to each other,
or the pixel units in the display unit are located in the same column and in different rows which are spaced apart by anther,
or the pixel units in the display unit are located in the same column and in different rows which are adjacent to each other and the pixel unit in the same column and the row which is adjacent receives higher BH than the other pixel unit in the display unit;
or the pixel units in the display unit are located in the same row and in different columns which are adjacent to each other and the pixel unit in the same row and the column which is adjacent receives higher BH than the other pixel unit in the display unit.

2. The driving method according to claim 1, the step of providing a gray level value, B, to the blue sub-pixels of each of the display units with a higher gray level value, BH, and a lower gray level value, BL further comprising:
S101, acquiring a relationship between the gray level value B₀ of the blue sub-pixel at a front viewing angle α and the actual brightness LvαB₀ in the curve B₀−LvαB₀;
S102, acquiring a relationship between the gray level value B₀ of the blue sub-pixel at a perspective viewing angle β and the actual brightness LvβB₀ in the curve B₀−LvβB₀;
S103, acquiring the relation curve B−LvαB and B−LvβB under the gray level value B and a theoretical brightness LvB at the front viewing angle α and the perspective viewing angle β in accordance with the equation
$${( \frac{B}{255} )}^{γ} = \frac{Lv α B}{Lv α ( 255 )} and {( \frac{B}{255} )}^{γ} = \frac{Lv β B}{Lv β ( 255 )} ,$$
wherein the Lvα(255) and Lvβ(255) are looked up from the relation curves B₀−LvαB₀ and B₀−LvβB₀; S104, BH and BL of the gray level value B to the blue sub pixels in the display unit are in accordance with the following equations:
Δ1=LvαB+LvαB−Lvα(BH)−Lvα(BL);
Δ2=LvβB+LvβB−Lvβ(BH)−Lvβ(BL);
y=Δ1²+Δ2²;
Wherein y is the minimum, LvαB and LvβB are looked up from curves B−LvαB and B−LvβB, Lvα(BH) and Lvα(BL) are looked up from B₀−LvαB₀, and Lvβ(BH) and Lvβ(BL) are looked up from B₀−LvβB₀; and
S105, resetting a look up table (LUT) for each of the gray level value B of the blue sub-pixels in the display unit to acquire a combination of BH and BL in accordance with S104.

3. The driving method according to claim 2, wherein the front viewing angle α is 0° and the perspective viewing angle β is 30˜80°.

4. The driving method according to claim 2, wherein the front viewing angle α is 0° and the perspective viewing angle β is 60°.

5. The driving method according to claim 2, wherein the pixel unit further comprises a red sub-pixel and a green-sub pixel, and the data signals of the red sub-pixel and the green sub-pixel is constant while resetting the data line signal of the blue sub-pixel.

6. The driving method according to claim 2, wherein the predetermined Gamma curve is γ=2.2

7. A liquid display panel comprising a gate controller, a source controller, and an active area having a plurality of pixel units in a matrix with M columns and N rows and at least one blue sub-pixel in each pixel unit, wherein the active area is divided into a plurality of display units and each of the display unit comprises two pixel units,
wherein the gate controller provides a scan signal to the pixel unit,
wherein the source controller provides a data signal to the pixel unit,
wherein a gray level value, B, is provided to the blue sub-pixels of each of the display units with a higher gray level value, BH, and a lower gray level value, BL, to each of the blue sub-pixels respectively, and the combination of BH and BL results the blue sub-pixels in the display unit to approach a predetermined Gamma Curve, and γ=1.8˜2.4 at a perspective viewing angle;
wherein the pixel units in the display unit are adjacent to each other,
or the pixel units in the display unit are located in the same column and in different rows which are spaced apart by anther, the pixel units in the display unit are located in the same column and in different rows which are adjacent to each other and the pixel unit in the same column and the row which is adjacent receives higher BH than the other pixel unit in the display unit, or the pixel units in the display unit are located in the same row and in different columns which are adjacent to each other and the pixel unit in the same row and the column which is adjacent receives higher BH than the other pixel unit in the display unit.

8. The liquid crystal panel according to claim 7, the step of providing a gray level value, B, to the blue sub-pixels of each of the display units with a higher gray level value, BH, and a lower gray level value, BL further comprising:
S101, acquiring a relationship between the gray level value B₀ of the blue sub-pixel at a front viewing angle α and the actual brightness LvαB₀ in the curve B₀−LvαB₀;
S102, acquiring a relationship between the gray level value B₀ of the blue sub-pixel at a perspective viewing angle β and the actual brightness LvβB₀ in the curve B₀−LvβB₀;
S104, BH and BL of the gray level value B to the blue sub pixels in the display unit are in accordance with the following equations:
Δ1=LvαB+LvαB−Lvα(BH)−Lvα(BL);
Δ2=LvβB+LvβB−Lvβ(BH)−Lvβ(BL);
y=Δ1²+Δ2²;
Wherein y is the minimum, LvαB and LvβB are looked up from curves B−LvαB and B−LvβB, Lvα(BH) and Lvα(BL) are looked up from B₀−LvαB₀, and Lvβ(BH) and Lvβ(BL) are looked up from B₀−LvβB₀; and
S104, BH and BL of the gray level value B to the blue sub pixels in the display unit are in accordance with the following equations:
Δ1=LvαB+LvαB−Lvα(BH)−Lvα(BL);
Δ2=LvβB+LvβB−Lvβ(BH)−Lvβ(BL);
y=Δ1²+Δ2²;
Wherein y is the minimum, LvαB and LvβB are looked up from curves B−LvαB and B−LvβB, Lvα(BH) and Lvα(BL) are looked up from B₀−LvαB₀, and Lvβ(BH) and Lvβ(BL) are looked up from B₀−LvβB₀; and
S105, resetting a look up table (LUT) for each of the gray level value B of the blue sub-pixels in the display unit to acquire a combination of BH and BL in accordance with S104

9. The liquid crystal panel according to claim 8, wherein the front viewing angle α is 0° and the perspective viewing angle β is 30˜80°.

10. liquid crystal panel according to claim 8, wherein the front viewing angle α is 0° and the perspective viewing angle β is 60°.

11. The liquid crystal panel according to claim 8, wherein the pixel unit further comprises a red sub-pixel and a green-sub pixel, and the data signals of the red sub-pixel and the green sub-pixel is constant while resetting the data line signal of the blue sub-pixel.

12. The liquid crystal panel according to claim 8, wherein the predetermined Gamma curve is γ=2.2.
